(19) United States
(12) Patent Application Publication
(10) Pub. No.: US 2008/0125026 A1
(43) Pub. Date: May 29, 2008

(54) Air vent for vehicle

(76) Inventor: Jae Woo Shin, Gwacheon-si (KR)

Correspondence Address: MORGAN, LEWIS & BOCKIUS LLP (SF), One Market, Spear Street Tower, Suite 2800, San Francisco, CA, 94105, US

(21) Appl. No.: 11/647,456

(22) Filed: Dec. 27, 2006

(30) Foreign Application Priority Data
Oct. 25, 2006 (KR) 10-2006-0104144

(51) Int. Cl. B60H 1/00; B60Q 1/00; B24D 13/00

(52) U.S. Cl. 454/69; 362/459

(57) ABSTRACT

An air vent for a vehicle includes a housing, a user-manipulable grill on a front of the housing, and a lamp mounted in the housing. A user can recognize the amount of opening of the vent based on the amount of light.

### CROSS-REFERENCE TO RELATED APPLICATION

This application claims priority to and the benefit of Korean Patent Application No. 10-2006-0104144 filed in the Korean Intellectual Property Office on Oct. 25, 2006, the entire contents of which are incorporated herein by reference.

### BACKGROUND OF THE INVENTION

(a) Field of the Invention

The present invention relates to an air vent for a vehicle, and more particularly to an air vent for a vehicle in which a user can easily recognize the opening amount of the vent.

(b) Description of the Related Art

Generally, an air conditioning system includes an air vent grill installed at an end of a duct and regulating air direction. The air vent grill includes overlapping horizontal and vertical blades within a rectangular hollow case in a lattice shape. Direction of air sent from the blower unit is regulated by change of slant angles of the blades. The blades are rotatably connected to the air vent housing, and angles thereof are adjusted by a control knob.

The horizontal blades are usually disposed at a front portion of the air vent grill and the vertical blades are disposed behind the horizontal blades. The slant angle of the horizontal blades is thus easily seen, but it is difficult to see the slant angle of the vertical blades.

### SUMMARY OF THE INVENTION

The present invention provides an air vent for a vehicle in which a lamp is mounted to an inside of an air vent grill such that a user can recognize an amount of opening of blades on the basis of the amount of light and can adjust direction and amount of air by manipulating a control knob.

The lamp may be mounted to any one of a top, a bottom, or an inner side of the air vent grill so as to illuminate light toward a side rather than a front, thereby preventing a user's eye from being dazzled.

### BRIEF DESCRIPTION OF THE DRAWINGS

FIG. 1 is a perspective view of an air vent for a vehicle according to an exemplary embodiment of the present invention.

FIG. 2 is front view of the air vent of FIG. 1.

### DETAILED DESCRIPTION OF THE PREFERRED EMBODIMENTS

An exemplary embodiment of the present invention will hereinafter be described in detail with reference to the accompanying drawings.

As shown in FIG. 2, in an air vent for a vehicle according to an exemplary embodiment of the present invention, a control knob 12 is manipulated to adjust slant angles of horizontal blades 13 and vertical blades 14.

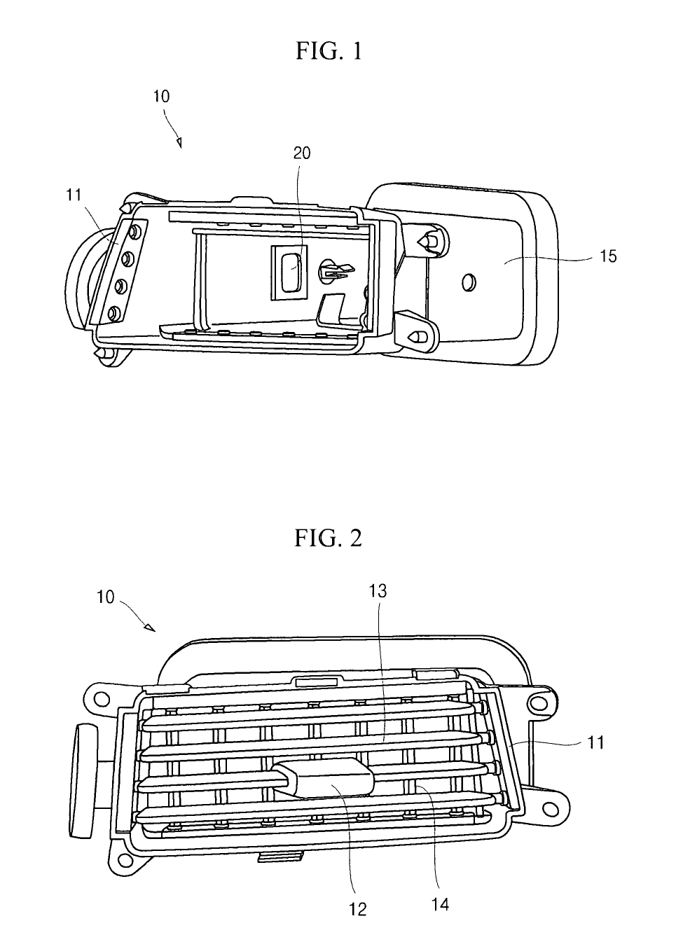

Referring to FIG. 1, a lamp 20 is mounted to an inside of the air vent grill 11, any one of a top, a bottom, or an inside of the air vent grill 11 is illuminated.

Amount of light transmitted to a user varies depending on amount of opening of the horizontal blades 13 and the vertical blades 14, and while a user looks at the front of the air vent grill 11, as the control knob is moved toward a side where amount of light is greater than the other side, the air is directed toward the user.

Meanwhile, the lamp 20 is disposed at the inside of the air vent grill 11 such that light is illuminated toward the side rather than the front, so when a user sees the front of the air vent, the light does not dazzle the eye of the user.

In operation, the user adjusts the vertical blades 14 to be parallel with his line of sight, and then adjusts the horizontal blades 13, so a user can easily adjust direction and amount of air by regulating the amount of light transmitted to the eye.

For example, when the user wants to adjust the direction and amount of wind toward his face, he adjusts the control knob 12 to a position where the light is brightest.

Accordingly, since changes of angles of the horizontal and vertical blades 13 and 14 of the air vent can be easily recognized, direction and amount of air can be easily recognized, so direction and amount of air can be simply adjusted by manipulating the control knob 12 a single time rather than several times.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An air vent for a vehicle, comprising:
a housing;
a user-manipulable grill on a front of the housing; and
a lamp mounted in the housing.

2. The air vent of claim 1, wherein the lamp is mounted to any one of a top, a bottom, or an inner side of the housing.
